(19) United States
(12) Patent Application Publication
(10) Pub. No.: US 2023/0352828 A1
(43) Pub. Date: Nov. 2, 2023

(54) REDIRECTING STRUCTURE FOR ELECTROMAGNETIC WAVES

(71) Applicant: HUAWEI TECHNOLOGIES CO., LTD., Shenzhen (CN)

(72) Inventors: Janne Ilvonen, Helsinki (FI); Resti Montoya Moreno, Helsinki (FI); Alexander Khripkov, Helsinki (FI); Ruiyuan Tian, Helsinki (FI)

(21) Appl. No.: 18/338,979

(22) Filed: Jun. 21, 2023

Related U.S. Application Data
(63) Continuation of application No. PCT/EP2020/087487, filed on Dec. 21, 2020.

(51) Int. Cl. H01Q 3/26

(52) U.S. Cl. CPC H01Q 3/2611; H01Q 3/2682

(57) ABSTRACT

A redirection structure for electromagnetic waves includes a multilayer structure and at least one antenna element. The multilayer structure includes a first conductive element, a conductive substrate, and a dielectric substrate arranged between the first conductive element and the conductive substrate and forming a wave guide. The antenna element is arranged adjacent an edge of the multilayer structure at an interface, the electromagnetic waves at least partially propagating in the wave guide along a first direction. The redirection structure further includes at least one dielectric cavity arranged at a predefined distance from the interface along the first direction. The dielectric cavity extends in a second direction away from the dielectric substrate at least partially through the conductive substrate.

### CROSS-REFERENCE TO RELATED APPLICATIONS

This application is a continuation of International Application No. PCT/EP2020/087487, filed on Dec. 21, 2020, the disclosure of which is hereby incorporated by reference in its entirety.

### FIELD

The disclosure relates to a redirecting structure for electromagnetic waves, the redirecting structure comprising a multilayer structure and at least one antenna element configured to emit electromagnetic waves.

### BACKGROUND

Mobile electronic devices such as smartphones and tablets have to support more and more radio signal technology including 5G radio technology. For 5G, the frequency range will be in the so-called millimeter-wave (mmWave) frequency range, i.e. between approximately 30 and 300 GHz.

However, millimeter-wave antennas are currently incompatible with organic light emitting diode (OLED) display panels, which are commonly used in mobile electronic devices. A typical implementation of an OLED panel comprises an OLED layer arranged between an indium tin oxide (ITO) layer and an electromagnetic interference (EMI) layer. The EMI layer is used for protection against electromagnetic interference and typically consists of conductive metal tape. The OLED layer also comprises metal, and between the OLED layer and the EMI layer there is a dielectric substrate. If a mmWave antenna is embedded next to the display, an electric field (e-field) would be generated between the OLED layer and the EMI layer. In other words, the energy of the millimeter waves emitted by the mmWave antenna would be partially absorbed between the OLED layer and the EMI layer, this part of the emitted energy effectively being lost from the far field of the mmWave antenna. For example, common mode mmWave antennas would generate significant energy leakage between the OLED layer and EMI tape, such that an efficiency drop of 2-5 dB could be caused for display-side mmWave antennas. This efficiency drop would affect the mmWave antenna in both the transmitting and receiving directions.

Such leakage could theoretically be eliminated by removing the gap between the OLED layer and EMI tape, e.g. by galvanically closing the gap using e.g. copper tape or conductive paint instead of the dielectric substrate. However, this could negatively affect the operation of the OLED panel and proper shielding may be challenging to implement. It is therefore not useful in practice.

Another solution would be to implement high impedance surfaces (HIS). HIS have been used for many years in the antenna field in order to prevent surface waves from propagating on a ground plane or metal sheet. A smooth conducting sheet has a low surface impedance, but by changing its geometry or adding corrugations to it, it's possible to achieve high surface impedance. As a result, surface wave propagation on the surface can be stopped.

However, current HIS solutions cannot be directly implemented on apparatuses that have an OLED panel without affecting the performance and reliability of the OLED panel negatively.

### SUMMARY

The present disclosure provides an improved electromagnetic wave redirecting structure.

According to a first aspect, there is provided a redirection structure for electromagnetic waves comprising a multilayer structure comprising a first conductive element, a conductive substrate, and a dielectric substrate, the dielectric substrate being arranged between the first conductive element and the conductive substrate, and forming a wave guide. The redirection structure furthermore comprises at least one antenna element configured to emit electromagnetic waves having a wavelength, the antenna element being arranged adjacent an edge of the multilayer structure at an interface, and the electromagnetic waves at least partially propagating in the wave guide along a first direction. Additionally, the redirection structure comprises at least one dielectric cavity arranged at a predefined distance from the interface along the first direction, the dielectric cavity extending in a second direction, extending perpendicular to the first direction and away from the dielectric substrate at least partially through the conductive substrate.

Such a structure facilitates an arrangement which prevents destructive electromagnetic waves from propagating through passages existing between the conductive elements of an apparatus, such as between the display and the frame of a smartphone. Propagation of electromagnetic waves through such passages, i.e. energy leakage, at mmWave frequencies causes undesired degradation of the radiation pattern as well as power loss. Furthermore, the structure eliminates the need for galvanic grounding of conductive elements, such as the display, reducing the risk of hotspots in the display and heat transfer related issues. In addition, galvanic grounding may be unreliable and its location may be critical for the antenna structure itself. The present solution allows electromagnetic waves to be redirected such that antenna directivity toward the desired direction will be maximized. The dielectric cavity of the redirecting structure prevents e.g. mmWave signals from propagating between the conductive element and conductive substrate, and is suitable for many types of antennas, not only mmWave antennas. This enables the use of e.g. 5G mmWave common mode display-side antennas.

In a possible implementation form of the first aspect, the redirection structure further comprises a second conductive element arranged between the dielectric substrate and the conductive substrate, the dielectric cavity extending in the second direction through the second conductive element. This allows the dielectric cavity to be formed within an existing component, such that the redirection structure does not necessitate specific, separate components.

In a further possible implementation form of the first aspect, the dielectric substrate comprises a dielectric material having a dielectric constant Dk between 1 and 4, which allows the dielectric substrate to be part of a multilayer structure such as an OLED panel.

In a further possible implementation form of the first aspect, the distance is less than 2λ, reducing the amount of leaked energy.

In a further possible implementation form of the first aspect, the distance is between λ/\sqrt{Dk/3} and λ/\sqrt{Dk/8}, which reduces the amount of leaked energy significantly, improving performance and allowing a wide operating range.

In a further possible implementation form of the first aspect, the dielectric cavity has a width in the first direction, the width being less than 2λ, in order to avoid poor performance at 40 GHz.

In a further possible implementation form of the first aspect, the dielectric cavity has a width in the first direction which is between λ/2-λ/5, giving the best performance as well as a wide operating range.

In a further possible implementation form of the first aspect, the dielectric cavity has a height in the second direction, the height being at least 0.1 mm, preferably 0.5 mm or less. This allows highly efficient redirection, while keeping the height of the structure as low as possible such that the internal dimensions of the apparatus comprising the structure remain unaffected by the structure.

In a further possible implementation form of the first aspect, the surfaces forming the dielectric cavity are straight in a plane perpendicular to the second direction, facilitating improved beam-steering or beam-tilting.

In a further possible implementation form of the first aspect, the surfaces forming the dielectric cavity are curved in a plane perpendicular to the second direction, facilitating improved beam-steering or beam-tilting.

In a further possible implementation form of the first aspect, the first conductive element, the second conductive element, and the dielectric substrate are part of a display panel, optionally an OLED panel. The solution addresses the issue of leaking energy without requiring modifications to be made to the display panel itself.

In a further possible implementation form of the first aspect, the first conductive element is an OLED layer, optionally a thin film transistor layer. This allows a thin and simple display to be used, while still achieving the desired redirection capabilities.

In a further possible implementation form of the first aspect, the second conductive element is an electromagnetic interference layer. This allows the redirection to be formed by already existing components, avoiding the need for additional components specifically directed towards redirection.

In a further possible implementation form of the first aspect, the conductive substrate is a printed circuit board, a liquid crystal polymer printed circuit board, or a further element arranged between the dielectric substrate and one of a printed circuit board and a liquid crystal polymer printed circuit board. This facilitates redirection of electromagnetic waves without having to use more components than those already available.

In a further possible implementation form of the first aspect, the further element is a conductive gasket or foam, allowing a commonly used component to form part of the redirection structure.

In a further possible implementation form of the first aspect, the dielectric cavity is partially formed by a vertical interconnect access extending within the printed circuit board or the liquid crystal polymer printed circuit board.

In a further possible implementation form of the first aspect the electromagnetic waves are within a frequency range of 10 to 300 GHz and have a wavelength of 1 to 30 mm.

In a further possible implementation form of the first aspect, the dielectric cavity forms an impedance discontinuity, the wave guide having a first impedance adjacent a section of conductive material of the second conductive element or a section of conductive material of the conductive substrate, and a second impedance adjacent the dielectric cavity, the second impedance being larger than the first impedance. The second impedance causes a large part of the electromagnetic waves to be reflected back towards the antenna element.

In a further possible implementation form of the first aspect, the impedance discontinuity reflects the electromagnetic waves propagating in the wave guide back towards the antenna element, reducing the electric field generated in the wave guide.

In a further possible implementation form of the first aspect, the redirection structure comprises a first dielectric cavity arranged at a first predefined distance from the interface along the first direction, and at least a second dielectric cavity arranged at a second predefined distance from the interface along the first direction, the first dielectric cavity and the second dielectric cavity being separated by a section of conductive material of the conductive substrate and optionally a section of conductive material of the second conductive element, enabling multiband or wideband operation.

In a further possible implementation form of the first aspect, the first dielectric cavity and the second dielectric cavity have the same or different widths or heights, allowing maximum flexibility.

According to a second aspect, there is provided an apparatus comprising the redirection structure according to the above, a display, and a frame, the first conductive element, the second conductive element and the dielectric substrate of the redirection structure being part of the display, the frame comprising at least a peripheral frame section at least partially surrounding a peripheral edge of the display, the antenna element of the redirection structure being arranged between the peripheral frame section and the peripheral edge of the display.

In such an apparatus, destructive radiation fields are prevented from propagating through passages existing between e.g. the display and the frame of the apparatus. This, in turn, prevents undesired degradation of the radiation pattern and power loss. Furthermore, the risk of hotspots in the display and heat transfer related issues are reduced. The apparatus can comprise many types of antennas, not only mmWave antennas.

These and other aspects will be apparent from the embodiments described below.

### BRIEF DESCRIPTION OF THE DRAWINGS

In the following detailed portion of the present disclosure, the aspects, embodiments and implementations will be explained in more detail with reference to the examples shown in the drawings, in which:

FIG. 1 shows a schematic side view of a redirection structure according to an example of the embodiments of the disclosure;

FIG. 2 shows a schematic side view of a redirection structure according to an example of the embodiments of the disclosure;

FIG. 3 shows a partial cross-sectional view of a redirection structure according to an example of the embodiments of the disclosure;

FIGS. 4a and 4b show top and bottom perspective views of an apparatus according to an example of the embodiments of the disclosure;

FIGS. 5a and 5b show schematic top views of the dielectric cavities of redirection structures according to examples of the embodiments of the disclosure;

FIG. 6 shows a schematic cross-sectional view of a multilayer structure according to an example of the embodiments of the disclosure.

### DETAILED DESCRIPTION

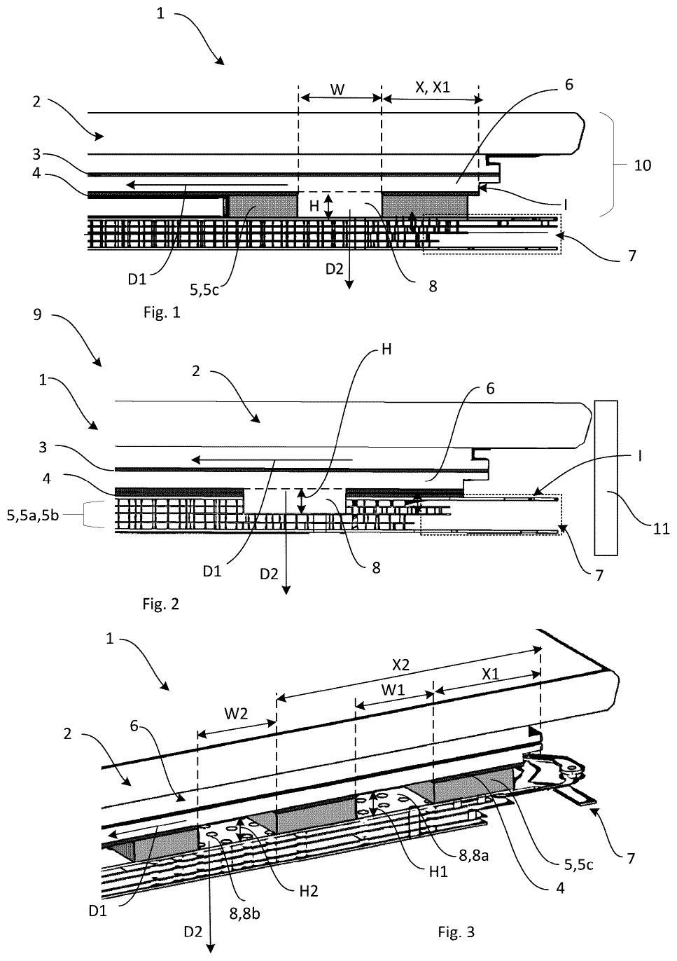

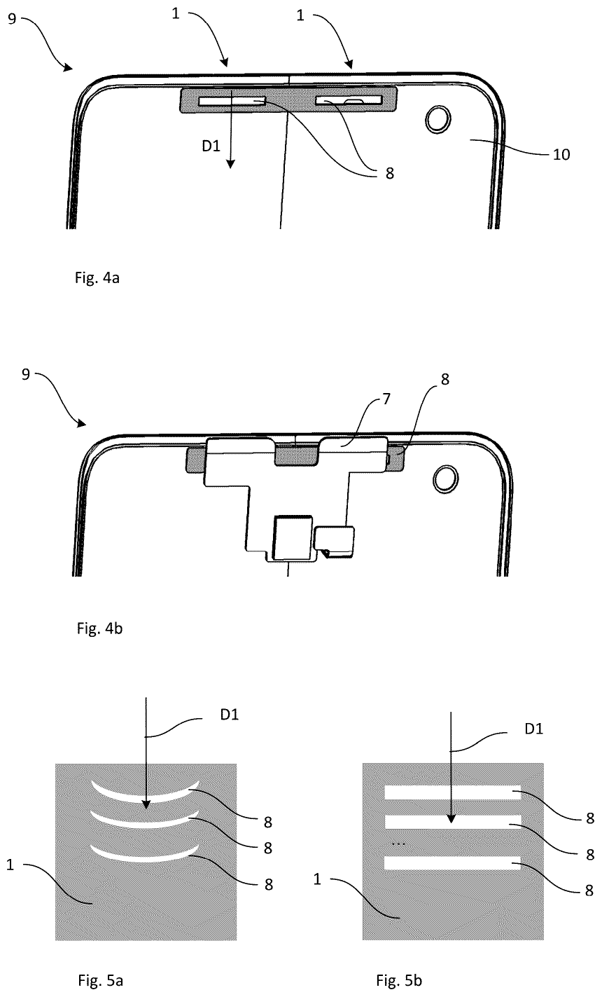

FIGS. 1 to 3 show different examples of a redirection structure 1 for electromagnetic waves comprising a multilayer structure 2, at least one antenna element 7, and at least one dielectric cavity 8. Several antenna elements 7 may be arranged in one antenna array. Several antenna arrays, e.g. two, may be provided as shown in FIGS. 4a and 4b. The electromagnetic waves may be within a frequency range of 10 to 300 GHz and have a wavelength λ of 1 to 30 mm.

The redirection structure 1 for electromagnetic waves comprises a multilayer structure 2 comprising a first conductive element 3, a conductive substrate 5, and a dielectric substrate 6. The dielectric substrate 6 is arranged between the first conductive element 3 and the conductive substrate 5 and forms a wave guide. At least one antenna element 7 is configured to emit electromagnetic waves having a wavelength 2. The antenna element 7 is arranged adjacent an edge of the multilayer structure 2 at an interface I, and the electromagnetic waves at least partially propagate in the wave guide 6 along a first direction D1. At least one dielectric cavity 8 is arranged at a predefined distance X from the interface I along the first direction D1. The dielectric cavity 8 extends in a second direction D2, extending perpendicular to the first direction D1 and away from the dielectric substrate 6 at least partially through the conductive substrate 5.

The antenna element 7, or antenna array, is configured to emit electromagnetic waves having a wavelength λ as the waves propagate through a substrate such as the dielectric substrate 6 discussed further below. The antenna element 7, or antenna array, is arranged adjacent an edge of the multilayer structure 2 at an interface I, as shown in FIGS. 1 and 2.

Electromagnetic waves propagate at least partially in the wave guide 6 along a first direction D1, i.e. a direction of propagation which reduces the performance of the antenna element 7 or antenna array. This is also referred to as energy leakage.

The multilayer structure 2 comprises a first conductive element 3, a conductive substrate 5, and a dielectric substrate 6. The dielectric substrate 6 is arranged between the first conductive element 3 and the conductive substrate 5 and forms a wave guide for electromagnetic waves. The dielectric substrate 6 may have a dielectric constant Dk between 1 and 4. Furthermore, the dielectric substrate 6 may comprise of a foam or adhesive material.

The conductive substrate 5 may be a printed circuit board 5a or a liquid crystal polymer printed circuit board 5b as shown in FIG. 1. The conductive substrate may also be a further element 5c, as shown in FIG. 2, arranged between the dielectric substrate 6 and one of a printed circuit board and a liquid crystal polymer printed circuit board. In other words, the conductive substrate 5 may either be a printed circuit board 5a or a liquid crystal polymer printed circuit board 5b or connected to a printed circuit board 5a or a liquid crystal polymer printed circuit board 5b. The further element 5c may be a conductive gasket or foam. A gasket, e.g. tape, is used to attach a display panel to a printed circuit board or a liquid crystal polymer printed circuit board. The thickness of the gasket is typically 0.125-0.5 mm.

The at least one dielectric cavity 8 is arranged at a predefined distance X from the interface I along the first direction D1. The dielectric cavity 8 needs to be at a certain distance away from the edge of the antenna element 7, or the antenna array. The distance X may be less than double the wavelength, i.e. 2λ, and is preferably between λ/\sqrt{Dk/3} and λ/\sqrt{Dk/8}.

The dielectric cavity 8 has a height, i.e. extends in a second direction D2 which extends perpendicular to the first direction D1. The dielectric cavity 8 extends away from the dielectric substrate 6, i.e. from the bottom of the dielectric substrate 6, and at least partially through the conductive substrate 5, i.e. forms a recess or opening in the conductive substrate 5. This prevents the dielectric cavity 8 from affecting the performance or reliability of the first conductive element 3.

The dielectric cavity 8 forms an impedance discontinuity. The wave guide 6 has a first impedance in a wave guide area adjacent, “adjacent” meaning e.g. above as shown in FIGS. 1 to 3, a section of conductive material of the conductive substrate 5 and optionally a section of conductive material of the second conductive element 4. The wave guide 6 also has a second impedance in a wave guide area adjacent, “adjacent” meaning e.g. above as shown in FIGS. 1 to 3, the dielectric cavity 8. The second impedance is larger than the first impedance. This difference in impedances forms an impedance discontinuity which partially reflects the electromagnetic waves, propagating in the wave guide 6, back towards the antenna element 7, reducing the electric field in the wave guide 6 and hence reducing absorption loss. The actual values of the first impedance and the second impedance depend on the dielectric substrate 6 and particularly on the height of the dielectric substrate 6.

The dielectric cavity 8 may be partially formed by a vertical interconnect access extending within the printed circuit board 5a or the liquid crystal polymer printed circuit board 5b.

The dielectric cavity 8 may have a width W in the first direction D1, the width W being less than 2λ, preferably between λ/2-λ/5. Furthermore, the dielectric cavity 8 may have a height H in the second direction D2, the height H being at least 0.1 mm, preferably 0.5 mm or less.

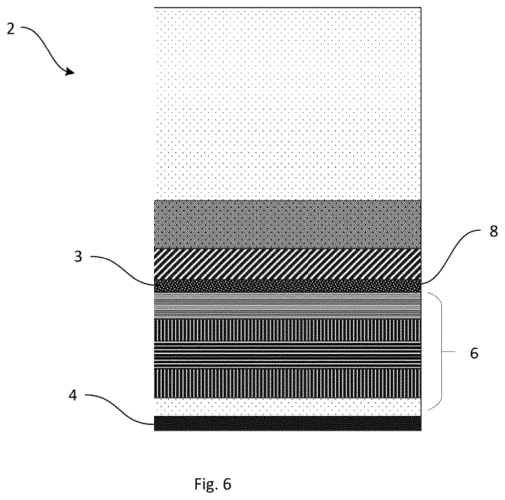

As shown in FIGS. 5a and 5b, the surfaces forming the dielectric cavity 8 may be straight and/or curved in a plane perpendicular to the second direction D2.

As shown in FIG. 3, the redirection structure 1 may comprise a first dielectric cavity 8a arranged at a first predefined distance X1 from the interface I along the first direction D1, and at least a second dielectric cavity 8b arranged at a second predefined distance X2 from the interface I along the first direction D1. By “at least a second dielectric cavity” is meant any suitable number of dielectric cavities. The first dielectric cavity 8a and the second dielectric cavity 8b are separated by a section of conductive material of the conductive substrate 5, and optionally by a section of conductive material of the second conductive element 4.

The first dielectric cavity 8a and the second dielectric cavity 8b may have the same or different widths W1, W2 and/or heights H1, H2.

As shown in FIGS. 1 to 3, the redirection structure may further comprise a second conductive element 4 arranged between the dielectric substrate 6 and the conductive substrate 5. In such examples of the redirection structure, the dielectric cavity 8 extends not only partially through the conductive substrate 5 but also through the second conductive element 4, in the second direction D2. I.e. the dielectric cavity 8 forms an opening in the second conductive element 4. The second conductive element 4 may be an electromagnetic interference layer, e.g. a metal tape made of copper. The electromagnetic interference layer is used for protection against electromagnetic interference.

The first conductive element 3, the second conductive element 4, and the dielectric substrate 6 may be part of a display panel, optionally an OLED panel as shown in FIG. 6. The first conductive element 3 may be an OLED layer, comprising metal and optionally being a thin film transistor layer. The OLED panel may comprise additional dielectric layers such as OLED pol, OLED black tape, OLED EMBO, OLED cushion, OLED PI, and one or several layers of optically clear adhesive. The OLED panel may also comprise a glass cover layer configured to form the outer protective surface of the OLED panel.

FIGS. 4a and 4b show an apparatus 9 comprising the above described redirection structure 1, as well as a display 10 and a frame 11. The first conductive element 3, the second conductive element 4 and the dielectric substrate 6 of the redirection structure 1 are part of the display 10. The frame 11 comprises at least a peripheral frame section at least partially surrounding a peripheral edge of the display 10, and the antenna element 7, or antenna array, of the redirection structure 1 is arranged between the peripheral frame section and the peripheral edge of the display 10.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure. As used in the description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

What is claimed is:

1. A redirection structure for electromagnetic waves, the redirection structure comprising:
a multilayer structure comprising a first conductive element, a conductive substrate, and a dielectric substrate, the dielectric substrate being arranged between the first conductive element and the conductive substrate, and forming a wave guide;
at least one antenna element configured to emit electromagnetic waves having a wavelength (λ), the antenna element being arranged adjacent to an edge of the multilayer structure at an interface, the electromagnetic waves at least partially propagating in the wave guide along a first direction; and
at least one dielectric cavity arranged at a predefined distance from the interface along the first direction, the dielectric cavity extending in a second direction,
wherein the second direction extends perpendicular to the first direction and away from the dielectric substrate at least partially through the conductive substrate.

2. The redirection structure according to claim 1, further comprising a second conductive element arranged between the dielectric substrate and the conductive substrate,
wherein the dielectric cavity extends in the second direction through the second conductive element.

3. The redirection structure according to claim 1, wherein the dielectric substrate comprises a dielectric material having a dielectric constant (Dk) between 1 and 4.

4. The redirection structure according to claim 3, wherein the predefined distance is less than 2λ.

5. The redirection structure according to claim 4, wherein the predefined distance is between λ/\sqrt{Dk/3} and λ/\sqrt{Dk/8}.

6. The redirection structure according to claim 1, wherein the at least one dielectric cavity has a width in the first direction, wherein the width is less than 2λ.

7. The redirection structure according to claim 6, wherein the width is between λ/2-λ/5.

8. The redirection structure according to claim 1, wherein surfaces forming the dielectric cavity are straight in a plane perpendicular to the second direction.

9. The redirection structure according to claim 1, wherein surfaces forming the dielectric cavity are curved in a plane perpendicular to the second direction.

10. The redirection structure according to claim 1, wherein the first conductive element and the dielectric substrate are part of a display panel.

11. The redirection structure according to claim 1, wherein the first conductive element is an OLED layer.

12. The redirection structure according to claim 11, wherein the first conductive element is a thin film transistor layer.

13. The redirection structure according to claim 2, wherein the second conductive element is an electromagnetic interference layer.

14. The redirection structure according to claim 1, wherein the conductive substrate is a printed circuit board, a liquid crystal polymer printed circuit board, or a further element arranged between the dielectric substrate and one of the printed circuit board and the liquid crystal polymer printed circuit board.

15. The redirection structure according to claim 14, wherein the further element is a conductive gasket or foam.

16. The redirection structure according to claim 14, wherein the dielectric cavity is partially formed by a vertical interconnect access extending within the printed circuit board or said liquid crystal polymer printed circuit board.

17. The redirection structure according to claim 2, wherein the dielectric cavity forms an impedance discontinuity, the wave guide has a first impedance adjacent a section of conductive material of the second conductive element or a section of conductive material of the conductive substrate, and a second impedance adjacent the dielectric cavity, and wherein the second impedance is larger than the first impedance.

18. The redirection structure according to claim 2, comprising a first dielectric cavity arranged at a first predefined distance from the interface along the first direction, and
at least a second dielectric cavity arranged at a second predefined distance from the interface along the first direction,
wherein the first dielectric cavity and the second dielectric cavity are separated by a section of conductive material of the conductive substrate and optionally a section of conductive material of the second conductive element.

19. The redirection structure according to claim 17, wherein the first dielectric cavity and the second dielectric cavity have the same or different widths or heights.

20. An apparatus comprising the redirection structure according to claim 1, a display, and a frame, wherein:
the first conductive element, a second conductive element and the dielectric substrate of the redirection structure are part of the display,
the frame comprises at least a peripheral frame section at least partially surrounding a peripheral edge of the display, and
the antenna element of the redirection structure is arranged between the peripheral frame section and the peripheral edge of the display.
